(19) United States
(12) Patent Application Publication
(10) Pub. No.: US 2019/0373361 A1
(43) Pub. Date: Dec. 5, 2019

(54) Microphone with Selectable Segmented Diaphragm

(71) Applicant: Kamran Salehi, Roselle, IL (US)

(72) Inventor: Kamran Salehi, Roselle, IL (US)

(21) Appl. No.: 15/996,352

(22) Filed: Jun. 1, 2018

(51) Int. Cl. H04R 1/32; H04R 1/08; H04R 19/04

(52) U.S. Cl. CPC H04R 1/326; H04R 19/04; H04R 1/08

(57) ABSTRACT

The present invention offers a design, which enables selective use of portions of a microphone's diaphragm. The gold splattered surface of the diaphragm is divided into segments with enough distance between them so that they are not electrically connected to each other. A separate wire is connected to each segment. A user can select one of the segments or a combination of segments in order to change the frequency response and other sonic characteristics of the microphone to suite the sound source.

### FIELD OF INVENTION

This invention relates to microphones and more particularly to microphones offering selectable characteristics for frequency response and audio characteristics. Use of segmented diaphragms in condenser and ribbon microphones is presented here.

### PRIOR ART

Patent U820080152174A1: Selectable diaphragm condenser microphone, presents a design where two diaphragms of a two-sided condenser microphone capsule are made of material with different thickness providing user selectable frequency response.

Patent US20100296674A1: Variable pattern hanging microphone system with remote polar control, presents a design where signals from two condenser capsules are combined to provide user selectable polar pickup patterns.

Patent JP5201598B2: Condenser microphone, presents a design where two condenser capsules of different sizes are connected in series to improve the audio characteristics of the output signal.

U.S. Pat. No. 4,329,547A: Dual section electret microphone, presents a design with two back-to-back positioned electret condenser capsules to improve bass response of the microphone.

U.S. Pat. No. 4,862,507A: Microphone acoustic polar pattern converter, presents a design where a tubular part is fitted forward of the microphone head.

U.S. Pat. No. 4,888,807A: Variable pattern microphone system, presents a design where 3 capsules with different polar patterns are placed in the same housing and provides the user with the means to select the combination of their signals to obtain the desired polar pattern.

U.S. Pat. No. 2,328,941A: Electroacoustical apparatus, presents a design where by combining the output of two dynamic transducers in various ways user can select the desired polar pattern.

### BACKGROUND OF INVENTION

Condenser microphones have been in use for high fidelity recording for a number of years. Audio recording specialists use different microphones with various size diaphragms due to differences in their frequency response, among other factors. The frequency response characters of a microphone can enhance the tonal quality of a given sound source by emphasizing certain frequency ranges. Recording specialists try to find the microphone which yields the most desirable recordings for a given sound source.

The present invention provides a means to electronically select certain areas of a diaphragm in a condenser microphone for generating the output. For example, a user can select a small circular area in the center of the diaphragm or, select the entire area of the diaphragm. These selections produce different frequency response characteristics, as well as different ratios of harmonic content in the output, allowing a recording engineer to fine adjust the sonic character of a recording without having to change the microphone or its sound generating capsule.

### DETAILED DESCRIPTION

A condenser microphone's diaphragm is normally made by vacuum depositing gold molecules on a flexible membrane often made of a non conductive substance such as Mylar. The purpose of depositing gold molecules is to make the diaphragm conductive so that a capacitor can be formed between the diaphragm and the conductive back plate normally made of metals. In existing microphones, the entire gold splattered surface of the diaphragm is electrically conductive and functions as one pole of a capacitor.

Different portions of a diaphragm vibrate differently in response to an incoming sound wave. This is due to how the diaphragm is physically secured to the capsule.

If a wire is connected to the center of the diaphragm, the area close to the center is secured to the wire and its vibration in response to an incoming sound wave relatively restricted. So normally, larger diaphragms have higher low frequency response due to having more surface area which can vibrate more freely due to being far enough from secured areas.

In the present invention gold splattered surface of the diaphragm is divided into segments with enough distance between these segments so that they are not electrically connected to each other. This type of segmentation can be produced by placing a thin mask on the Maylar layer during vacuum depositing of gold. The areas which are covered by the mask will remain non-conductive.

A separate wire can be connected to each segment. So the user can select which segment or combination of segments of the diaphragm are used in forming a capacitor and producing electrical output from the microphone.

The selection of active segment or segments of the diaphragm can be achieved using switches which selectively connect the segments to the circuit of the microphone. Or alternatively, variable resistors may be used to allow uses to mix the output from each segment at the desired ratio.

Divisions of the diaphragm can be in different geometric shapes to take advantage of particular vibration characteristics dictated by the shape of geometric segments and how far they are from the areas where the diaphragm is secured to other components which keep it from freely moving. For example, the diaphragm segments can be in shapes of multiple concentric circles, or triangular, or rectangular segments can be used.

To offer more segmentation choices to a user, it is possible to use two approaches;

1—Place gold deposits on both sides of the diaphragm, segmented in different geometric shapes. 2—Use multiple layers of Mylar each one having different geometric shaped segments.

Application of this invention to ribbon microphones:

Another approach using this electric segmentation of vibrating diaphragm is to implement it in ribbon microphones.

In FIG. 5, top view of a ribbon made of Mylar with segments that are made conductive using vacuum gold depositing is presented. This is achieved by placing a mask on Mylar during vacuum depositing of gold. In FIGS. 5, 1 and 2 are the portions of Mylar that was covered using a mask and therefore does not have gold deposit on it and is non-conductive. 3, 4, and 5, are segments which are covered by gold deposit and are conductive.

In a ribbon microphone, the signal is produced by having a vibrating conductive ribbon in a magnetic field. One of the challenges with ribbon microphones is to produce high enough voltage so that the signal to noise ratio is acceptable. If a ribbon is segmented as pictured in FIG. 5, each of the segments will produce a certain voltage in output. By connecting these segments in series a higher voltage can be achieved. Alternatively, if the segments are connected in a parallel, a higher amperage can be achieved. These configurations have an effect on the resistance that the ribbon offers to vibration in a magnetic field. Also, due to difference in resistance to vibration, and also based on the electrical resistance of input of an amplifier, different sonic characteristics in the produced signal can be observed. As an example, let's assume that for a given sound, in a 3 segment ribbon, each segment will produce 0.002 volts and 0.003 amps of current. In such an example the two methods of combining the signals from each segment will have the following results:

Notation:

1, 2, 3=Segments 1, 2, 3

V=Voltage

V1=Volts from segment 1, etc.

A=Amps

A1=Amps from segment 1, etc.

Serial connection:

V=V1+V2+V3

V=0.002+0.002+0.002=0.006

A=A1=A2=A3=0.003

Parallel connection:

A=A1+A2+A3

A=0.003+0.003+0.003=0.009

V=V1=V2=V3=0.002

FIG. 6 shows how such a ribbon can be curled so that it vibrates more freely due to sound. This can be achieved by placing the Mylar ribbon after vacuum depositing of gold in a mold and heating it using an oven. If Mylar is heated to about 300F degrees, it will hold the shape of the mold after it is cooled inside the mold. In FIGS. 6; 1, 2, and 3 are segments that are covered by gold and are conductive. 4 and 5 are segments which were covered by a mask during vacuum depositing and are non-conductive.

FIG. 7 shows a ribbon where the conductive and non conductive segments have alternative geometric shapes. In this configuration, a user can select the signal from the segment with most of the area in the center as opposed to selecting the other segment with most of its area in the corners. Ribbons have always been fastened to the microphone from the two ends in ribbon microphones.

In this configuration, the center area is more distant from the ends which are fastened to the microphone. Therefore, the center area can vibrate more freely and produce more bass response to the sound waves.

In FIG. 7;

1 points to the entire ribbon.

2 is a very thin area of the ribbon covered by gold to provide an electrical connection to the center.

3 is the main central area of the ribbon covered by gold.

4 is the area of Mylar which was covered by a mask during vacuum depositing and is non conductive.

5 is one of the edge areas of the ribbon covered by gold.

6 is a very thin area of the ribbon covered by gold which electrically connects the edge areas of the ribbon.

There is yet another interesting application of segmentation conductive layer of a diaphragm to ribbon microphones. FIG. 8 shows a design where the ribbon can be connected to the rest of the microphone from one end, hanging from the top and letting gravity keep the ribbon in the magnetic field. This presents an exciting option since the ribbon is much more free to vibrate to sound compared to traditional ribbon microphones and can produce a very high fidelity output which corresponds extremely close to sound source. Similar to the other diaphragms (or ribbons) described previously, the ribbon is made of Mylar and parts of it are covered by a mask during the vacuum gold depositing to obtain the desired geometric shape for conductive parts. This type of ribbon does not need to be curled like traditional ribbons in microphones since the bottom end is completely free to vibrate with sound.

In FIG. 8;

1 is the entire ribbon.

2 is a conductive part of the ribbon which is very narrow and acts as a connection wire to the lower end of the ribbon. Since the area of this segment compared to main central part of the ribbon is a very small percentage, the electrical signal that is produced by its vibration in a magnetic field is negligible. FIG. 8 is not drawn to scale in order to make the small portions visible. In practice this conductive segment can be made as narrow as practically achievable in the manufacturing process.

3 is a non-conductive segment of the diaphragm.

4 is the main conductive segment of the diaphragm, occupying a high percentage of the entire area.

5 is another conductive narrow segment similar to 2. The reason for having two of these narrow segments on the two sides of the ribbon is to maintain symmetrical vibration of the ribbon in the magnetic field. Although these segments have a small area compared to 4, it is possible for them to offer some resistance to movement in accordance to sound vibrations in the magnetic field. In order to preserve symmetrical movement of the entire ribbon, two of these narrow segments are used as a balancing factor on the two elongated sides of the ribbon.

In this type of application, electrical connections are made from the top of the ribbon which is also where it hangs from. Allowing a type of “free floating” installation in the microphone body where only one end of the ribbon, namely the top end, is fastened to the microphone.

### BRIEF DESCRIPTION OF THE DRAWINGS

FIG. 1 is a top view of a condenser microphone diaphragm with electrically segmented conductive layer.

FIG. 2 is a side view of a cross section of condenser microphone diaphragm with electrically segmented conductive layer. This cross section is shown as passing near the center of the diaphragm.

FIG. 3 shows an exploded view of a condenser microphone capsule and its parts, including a diaphragm with electronically segmented conductive layer.

FIG. 4 shows an assembled view of a condenser microphone capsule and its parts, including a diaphragm with electronically segmented conductive layer.

FIG. 5 is a top view of an electrically segmented diaphragm for a ribbon microphone, before the ribbon is curled.

FIG. 6 is a side view of an electrically segmented diaphragm for a ribbon microphone, after the ribbon is curled using heat treatment.

FIG. 7 is a top view of an electrically segmented diaphragm for a ribbon microphone, before the ribbon is curled, with an alternate geometric configuration for segments.

### Preferred Embodiment

An embodiment is presented here, as an example, and by no means it should be assumed that it limits the scope of this invention and claims. Other embodiments may include various geometric shapes for the segments of the diaphragm, higher number of segments, various structures for the capsule, multiple segmented diaphragm layers, or capsules where both sides of the capsule have active segmented diaphragm. In fact, prototypes have been produced with two sided active and segmented diaphragm in order to fully test the varieties in sound which can be achieved. Other possible embodiments include ribbon type microphones.

Existing diaphragms currently in use, are made of 2 layers. Layer one is made of an elastic material such as Mylar which is electrically non conductive. The non conductive layer is covered by a very thin layer of electrically conductive material such as gold which is deposited on the elastic layer using vacuum depositing methods.

In normal existing diaphragms, the entire gold layer is electrically connected. Meaning that any point on the surface of this layer is electrically connected to any other point.

In order to convert sound waives to a corresponding electrical signal, a capacitor is formed by applying one pole of an electrical charge to the conductive layer of the diaphragm, and the other electrical pole to the back-plate of the capsule.

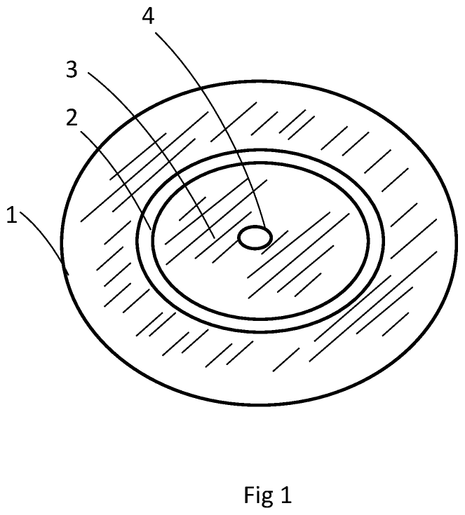

FIG. 1 shows a condenser microphone diaphragm with electrically segmented conductive layer.

To produce this type of diaphragm, a thin mask is placed on the Mylar layer when vacuum depositing is performed. This mask prevents some sections of the surface of Mylar from receiving gold deposit. Therefore, the entire conductive layer is not electrically connected.

In FIG. 1;

1 is the edge segment of the diaphragm which is Maylar layer covered by gold deposit.

2 is a segment of the diaphragm which was covered by a mask during vacuum depositing. Therefore, this segment is only Maylar without a gold layer and acts as an electrical insulator between segments.

3 is the center segment composed of Maylar and gold deposit on top of it.

4 is a hole in the center segment. When diaphragms is assembled in the capsule a screw is passed through this hole which keeps a wire connected to the center segment.

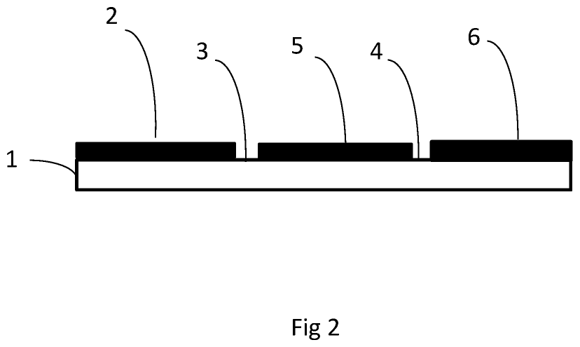

FIG. 2 is a side view of a cross section of condenser microphone diaphragm with electrically segmented conductive layer. This cross section is shown as passing near the center of the diaphragm. This diagram is not drawn to scale and layers are shown much thicker for clarification.

In FIG. 2;

1 is the Maylar layer.

2 is the edge segment of the diaphragm covered by gold deposits.

3 and 4 are sections of the Mylar which were covered by a mask during vacuum depositing. Therefore, these areas are only Mylar without a gold layer and act as an electrical insulator between other segments.

5 is the center segment composed of Mylar and gold deposit on top of it.

6 is the edge segment of the diaphragm covered by gold deposits.

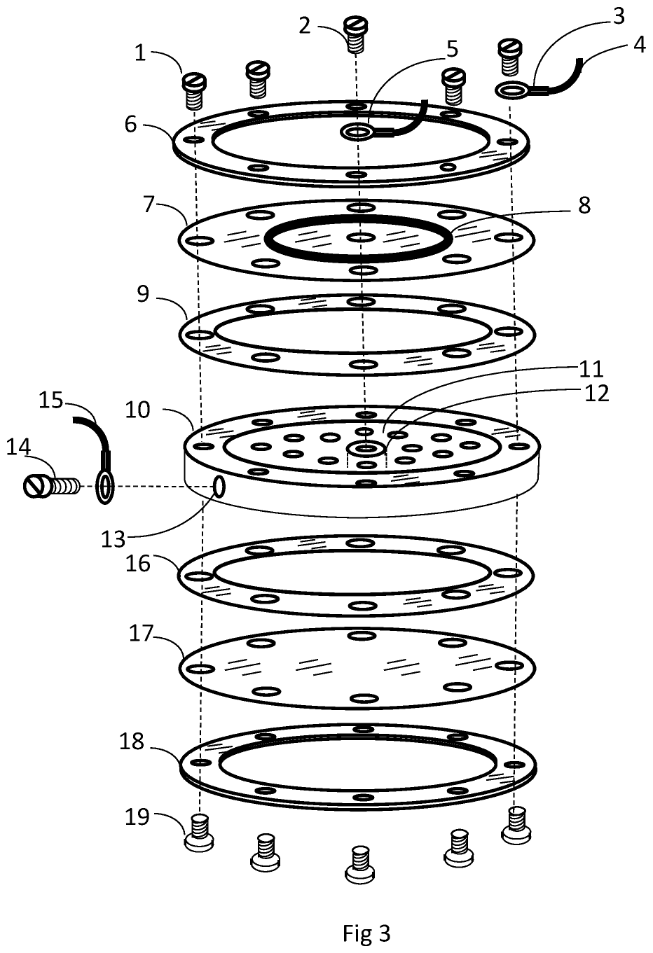

FIG. 3 shows an exploded view of the microphone capsule and its parts.

In FIG. 3,

1 is one of the screws which secure the retaining ring which holds the diaphragm attached to the capsule. All similar screws are not pictured here to prevent the drawing from being too busy.

2 is the screw which passes through the diaphragm and attaches a wire to the center segment of the diaphragm.

3 is one of the screws on the retaining ring, this particular screw also holds a wire in place which will have electrical contact with the edge segment of the diaphragm.

4 is the electrical wire which provides electrical connection to the edge segment of the diaphragm.

5 is the electrical wire which provides electrical contact to the center segment of the diaphragm. Wires 4 and 5 both include a small circular part at the end which acts like a washer and the corresponding screw will pass through it securing the wire in place.

6 is the retaining ring which holds the diaphragm in place. This ring will be made of metal and therefore electrically conductive. When assembled, this ring will be in contact with the edge segment of the diaphragm therefore providing electrical contact to wire 4.

7 is the segmented diaphragm. The holes shown around it will be formed when screws such as 1 are forced to pass the diaphragm during assembly.

8 is the non conductive portion of the diaphragm.

9 is a spacer ring. This ring will be made of non-conductive material such as Mylar and provides a distance between diaphragm and back-plate shown under it in the drawing. This space is needed in order to form a capacitor between diaphragm and back-plat. Vibration of diaphragm due to sound waves, changes the distance between diaphragm and back-plate changing the capacitance according to the sound waves.

10 is a portion of the back plate made of non conductive material such as plastic.

11 is a portion of the back-plate made of metal and therefore electrically conductive. This is the portion of the back-plate used in forming a capacitor.

12 is a cylindrical portion of the back-plate in the center made of non-conductive material such as plastic. This portion has a threaded hole in the center, which screw 2 is attached to.

13 is a hole in 10 which provides passage for screw 14. At the inner side of this hole, there is a threaded hole in 11 to mate with screw 14.

14 is a relatively long screw which passes through hole 13 and fastens to 11 which is the conductive portion of back-plate.

15 is an electrical wire with a washer at the end which provides electrical contact to the back-plate.

16 is another spacer ring, similar to 9.

17 is a resonating passive diaphragm which allows obtaining better frequency response from the capsule. It only has one layer made from Mylar.

18 is another retaining ring similar to 6.

19 is a screw for securing the retaining ring 18. Four other screws with similar function are shown.

The example embodiment shown in FIG. 3 is a single sided condenser capsule. Meaning that all the parts from 16 to 19 support a resonating passive diaphragm 17. Alternatively this diaphragm could also be an active and segmented one, for a two-sided capsule. Electrical connections with a similar structure as shown from 2 to 5 could be used for the second active side.

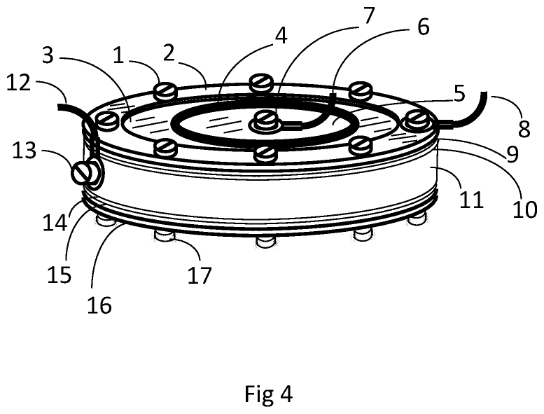

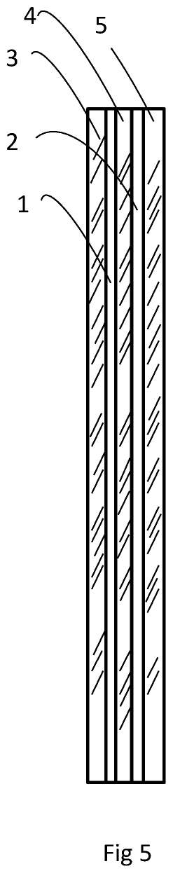

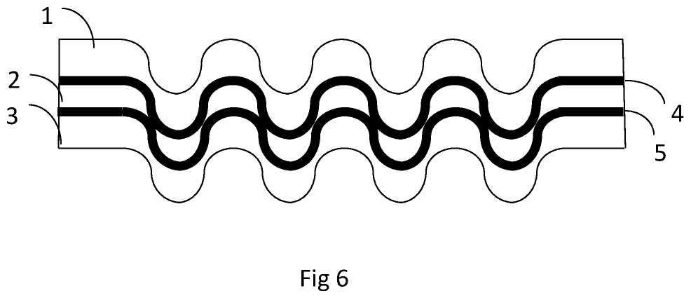

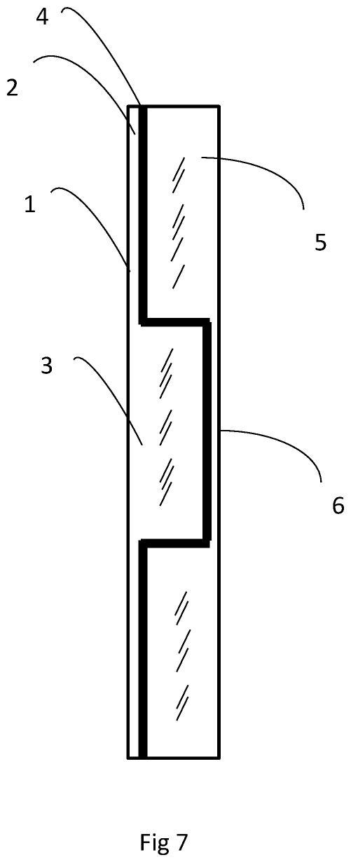

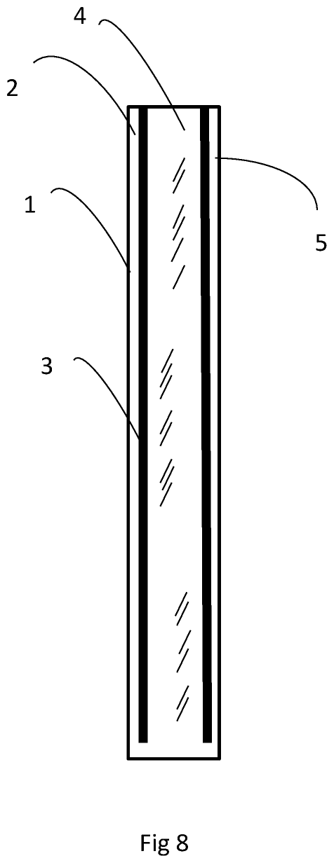

FIG. 4 shows an assembled view of a condenser microphone capsule and its parts, including a diaphragm with electronically segmented conductive layer.

In FIG. 4,

1 is one of the screws which secure the retaining ring, which holds the diaphragm attached to the capsule.

2 is the retaining ring which holds the diaphragm in place. This ring will be made of metal and therefore electrically conductive. When assembled, this ring will be in contact with the edge segment of the diaphragm therefore providing electrical contact.

3 is the conductive edge portion of the segmented diaphragm.

4 is the non-conductive portion of the diaphragm.

5 is the center conductive portion of the diaphragm.

6 is a wire attached to 5.

7 is the screw holding the wire 6 attached to 5, the center segment of the diphragm.

8 is a wire connected to the edge conductive segment of the diaphragm.

9 is the very thin side of diaphragm visible from side of the assembled capsule.

10 is the spacer separating the diaphragm from the back-plate. This is a non conductive ring made of Mylar.

11 is the back-plate. The outer non conductive portion is visible in this FIG.

12 is the wire attached to the back-plate.

13 is the screw holding the wire 12 in place.

14 is a thin spacer separating the resonating non-active diaphragm from the back-plate.

15 is a resonating passive diaphragm which allows obtaining better frequency response from the capsule.

16 is a retaining ring holding the resonating diaphragm in place.

17 is one of the screws holding the retaining ring for the resonating diaphragm.

1- Diaphragm of a microphone made of conductive and non-conductive layers, where the conductive layer is divided into two or more electrically insulated segments, with each segment having a separate electric connection to the circuit of the microphone.

2- A condenser microphone made with diaphragm in claim 1.

3- A microphone made with diaphragm in claim 1, where switches or variable resistors allow the user to select a segment, or a combination of segments, at equal or unequal ratios for generating the microphone output.

4- A condenser microphone capsule made with one or more diaphragms described in claim 1.

5- Use of a mask for vacuum depositing a metal on a microphone diaphragm described in claim 1.

6- Ribbon of a ribbon microphone made of conductive and non-conductive layers described in claim 1.

7- A microphone made with segmented ribbon described in claim 1.

8- Ribbon of a ribbon microphone made of conductive and non-conductive layers, where the conductive layer is divided into a main segment covering the majority of the ribbon surface, and one or more substantially narrower segments acting as connection wires.

9- Microphone made with a ribbon, where only top-end of the ribbon is secured to other parts of the microphone and bottom-end is free floating.
